(19) United States
(12) Patent Application Publication
(10) Pub. No.: US 2026/0100485 A1
(43) Pub. Date: Apr. 9, 2026

(54) BATTERY PACK AND METHOD FOR MANUFACTURING BATTERY PACK

(71) Applicants: Hyundai Motor Company, Seoul (KR); Kia Corporation, Seoul (KR)

(72) Inventors: Kyung Mo Kim, Hwaseong (KR); Si Won Kim, Hwaseong (KR); Gun Woo Ko, Hwaseong (KR)

(21) Appl. No.: 19/214,710

(22) Filed: May 21, 2025

(30) Foreign Application Priority Data
Oct. 8, 2024 (KR) 10-2024-0137127

(51) Int. Cl. H01M 50/505; H01M 10/613; H01M 10/6556; H01M 50/244; H01M 50/291; H01M 50/296

(52) U.S. Cl. CPC H01M 50/505; H01M 10/613; H01M 10/6556; H01M 50/244; H01M 50/291; H01M 50/296

(57) ABSTRACT

Provided is a battery pack including a battery housing, a plurality of battery cell stacks accommodated in an interior of the battery housing, and disposed to be spaced apart from each other in a first direction, and busbar extending between the plurality of battery cell stacks in the first direction, in a second direction crossing the first direction. The battery housing includes a base plate, on which the plurality of battery cell stacks are seated, a first cross member extending in the second direction between the plurality of battery cell stacks, and a busbar holder that fixes a position of the busbar between the first cross member and the base plate. A method of assembly includes mounting the busbar, installing the cell stacks around it, attaching cross members, and connecting a cover. The design simplifies busbar alignment, provides secure electrical connections, and offers a compact structure suited for efficient battery systems.

### CROSS-REFERENCE TO RELATED APPLICATION

This application claims under 35 U.S.C. § 119(a) the benefit of Korean Patent Application No. 10-2024-0137127, filed in the Korean Intellectual Property Office on Oct. 8, 2024, the entire contents of which are incorporated herein by reference.

### BACKGROUND

### Technical Field

The present disclosure relates to a battery pack, and a method for manufacturing the same.

### Background

Recently, as environmental awareness has increased and petroleum resources have declined, research and development on electric vehicles, which are eco-friendly vehicles, has been highlighted. Electric vehicles include plug-in hybrid electric vehicles (PHEVs), battery electric vehicle (BEVs), and fuel cell electric vehicles (FCEVs).

An electric vehicle typically includes a battery housing that supports battery cells. Meanwhile, an electric vehicle uses battery cells as a power source, and efforts have been made recently to increase a capacity of battery cells that are accommodated in an interior of the battery housing.

To enhance a capacity of the battery cells, the battery cells may be arranged in a cell to pack (CTP) configuration within the battery housing, rather than being grouped into modules. Meanwhile, a busbar for a high voltage may be installed in the interior of the battery housing. Then, cost reduction is required due to the busbar and parts for supporting the busbar.

In addition, if a fire starts inside the battery housing due to the battery cells, it may spread quickly. As a result, the need for measures that prevent or mitigate thermal runaway near the busbar is increasing.

### SUMMARY

At least some embodiments of the present disclosure have been made to solve the above-mentioned problems occurring in the existing technologies while advantages achieved by the existing technologies are maintained intact.

Some example embodiments of the present disclosure provide a battery pack that prevents a thermal runaway due to a busbar while costs of the busbar are reduced.

The technical problems to be solved by at least some embodiments of the present disclosure are not limited to the aforementioned problems, and any other technical problems not mentioned herein will be clearly understood from the following description by those skilled in the art to which the present disclosure pertains.

According to some example embodiments of the present disclosure, a battery pack includes a battery housing, a plurality of battery cell stacks configured to be accommodated in an interior of the battery housing, and disposed to be spaced apart from each other in a first direction, and a busbar extending in a second direction crossing the first direction between the plurality of battery cell stacks, and the battery housing includes a base plate, on which the plurality of battery cell stacks is configured to be seated, a first cross member extending in the second direction between the plurality of battery cell stacks, and a busbar holder that fixes a position of the busbar between the first cross member and the base plate.

The busbar holder may include a base wall fixed to the base plate, and a pair of side walls extending from the base wall to one side in a third direction crossing the first direction and the second direction and accommodating the busbar therebetween.

The busbar holder may further include a busbar support wall protruding from the base wall in the third direction between the pair of side walls and supporting the busbar.

A height of the busbar support wall in the third direction may be smaller than a height of the side walls in the third direction.

The battery pack may further include an inter-busbar configured to electrically connect the battery cell stacks arranged in parallel in the second direction, and the base wall may be configured to support the inter-busbar.

The base wall may include a base area connected to the side wall and the busbar support wall, and a protruding area protruding from the base area toward the battery cell stacks and coupled to the inter-busbar.

The inter-busbar may extend in the second direction and include opposite ends in the second direction, and wherein the protruding area may be coupled to the opposite ends of the inter-busbar.

The battery pack may further include a second cross member extending in the first direction to cross the first cross member between the opposite ends of the inter-busbar.

The battery pack may further include a coupling member coupling the opposite ends of the inter-busbar and the protruding area, when the busbar and the inter-busbar are viewed while being spaced apart from each other in the third direction, the busbar may include an area that is curved to become more distant from the opposite ends of the inter-busbar in the first direction.

The inter-busbar may be disposed between the busbar and the base wall.

When the busbar and the inter-busbar are viewed while being spaced apart from each other in the second direction, the inter-busbar may have a length in the first direction that is greater than a length in the third direction, and the busbar may be spaced apart from the inter-busbar in the third direction to have a length in the third direction being greater than a length in the first direction.

The battery cell stack may include battery cells extending in the first direction and arranged in the second direction, and a sensing assembly disposed on one side of the battery cells in the first direction and electrically connected to the inter-busbar.

The connection terminal may be provided on an area on an opposite side of the sensing assembly in the third direction.

The side wall may include a side connection area extending in the second direction, and side support areas arranged in the second direction with the side connection area interposed therebetween, having a height in the third direction that is greater than a height of the side connection area in the third direction, and supporting the busbar.

The side support area may include a part having a thickness in the first direction being greater than a thickness of the side connection area in the first direction.

The base plate may include a cooling channel in an interior thereof.

According to some example embodiments of the present disclosure, a method for manufacturing a battery pack includes mounting a busbar on a battery housing, mounting a plurality of battery cell stacks on the battery housing such that the plurality of battery cell stacks faces each other with the busbar interposed therebetween, mounting a first cross member and a second cross member in a direction crossing the first cross member, between the plurality of battery cell stacks, and coupling a pack cover to the battery housing.

The mounting the busbar on the battery housing may include fixing a busbar holder for fixing the busbar to a base plate and seating the busbar on the busbar holder.

The mounting the busbar on the battery housing may include fixing a busbar holder for fixing the busbar to a base plate, and mounting an inter-busbar for electrical connection of the battery cell stacks on the battery housing.

The mounting the plurality of battery cell stacks on the battery housing may include electrically connecting the inter-busbar and connection terminals of the battery cell stacks.

### BRIEF DESCRIPTION OF THE DRAWINGS

The above and other objects, features and advantages of the present disclosure will be more apparent from the following detailed description taken in conjunction with the accompanying drawings:

FIG. 1 is an exploded perspective view of a battery pack according to some example embodiments of the present disclosure;

FIG. 2 is a perspective view of a battery housing before an electric part module is mounted according to some example embodiments of the present disclosure;

FIG. 3 is a perspective view of a battery housing, on which an electric part module is mounted, according to some example embodiments of the present disclosure;

FIG. 4 is an enlarged view of portion “A” illustrated in FIG. 3;

FIG. 5 is an enlarged view of portion “B” illustrated in FIG. 3;

FIG. 6 is an enlarged view of portion “C” illustrated in FIG. 3;

FIG. 7 is a perspective view of a battery cell stack according to some embodiments of the present disclosure;

FIG. 8 is an enlarged view illustrating an inter-busbar, a connection terminal, and a busbar, between battery cell stacks according to some example embodiments of the present disclosure;

FIG. 9 is a cross-sectional view of a busbar, an inter-busbar, a connection terminal, and a base plate provided between battery cell stacks according to some example embodiments of the present disclosure; and

FIG. 10 is a flowchart illustrating a method for manufacturing a battery pack according to some example embodiments of the present disclosure.

### DETAILED DESCRIPTION

Hereinafter, embodiments of the present disclosure will be described in detail with reference to the accompanying drawings. In adding reference numerals to the components of the drawings, it is noted that the same components are denoted by the same reference numerals even when they are drawn in different drawings. Furthermore, in describing the embodiments of the present disclosure, when it is determined that a detailed description of related known configurations and functions may hinder understanding of the embodiments of the present disclosure, a detailed description thereof will be omitted.

Furthermore, in describing the components of the embodiments of the present disclosure, terms, such as first, second, “A”, “B”, (a), and (b) may be used. The terms are simply for distinguishing the components, and the essence, the sequence, and the order of the corresponding components are not limited by the terms. Unless defined differently, all the terms including technical or scientific terms have the same meanings as those generally understood by an ordinary person in the art, to which the present disclosure pertains. The terms, such as the terms defined in dictionaries, which are generally used, should be construed to coincide with the context meanings of the related technologies, and are not construed as ideal or excessively formal meanings unless explicitly defined in the present disclosure.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The term “battery cell stack” herein refers to a group of two or more battery cells arranged adjacent to one another in a layered or stacked configuration.

The term “busbar” herein refers to a conductive element that collects or distributes electric current.

The term “inter-busbar” herein refers to a secondary or auxiliary busbar used to interconnect batter cell stacks, enabling parallel or series electrical connections as needed.

The term “busbar holder” herein refers to a structural component configured to support or secure the busbar in a fixed spatial relationship with respect to the battery cell stacks.

The term “base plate” herein refers to a foundation or bottom panel of the battery housing on which the battery cell stacks, busbars, or other components are seated or mounted.

The term “cross member” herein refers to a reinforcing member or beam that extends across the battery cell stacks in a direction perpendicular or transverse to their primary alignment.

The term “side support area” herein refers to a portion of a side wall or busbar holder configured to provide mechanical support or alignment for the busbar or inter-busbar.

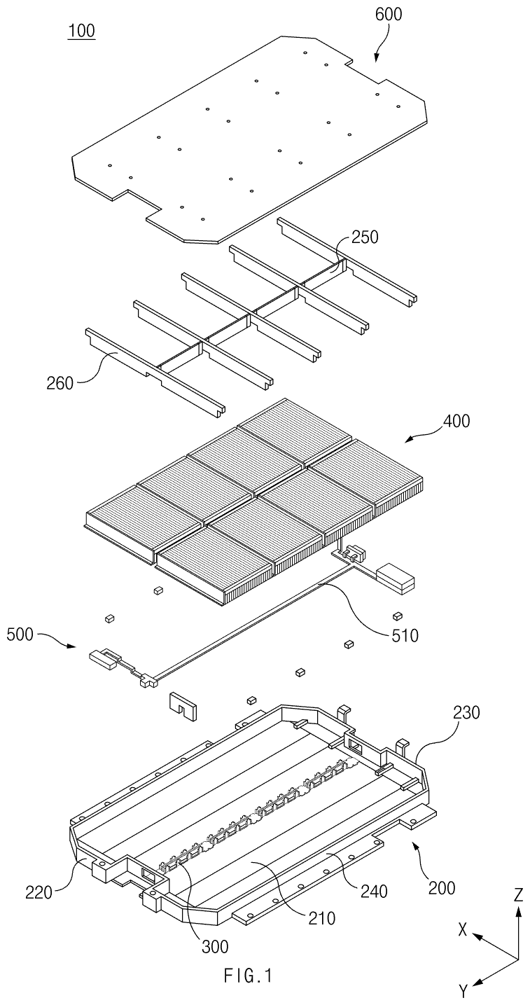

Hereinafter, embodiments of the present disclosure will be described in detail with reference to FIGS. 1 to 10. Hereinafter, a leftward/rightward direction may be a first direction, a forward/rearward direction may be a second direction, an upward/downward direction may be a third direction and the first to third directions may be directions that are perpendicular to each other.

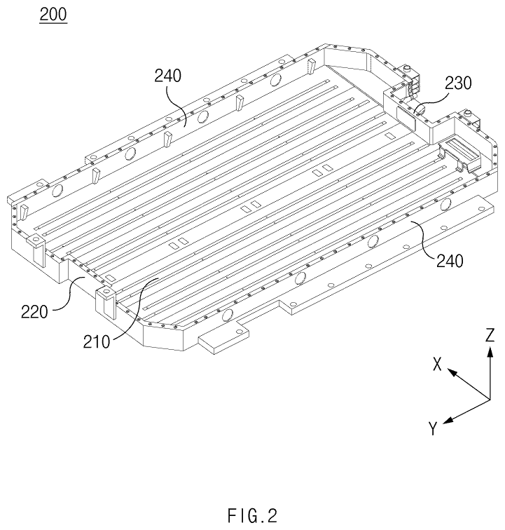

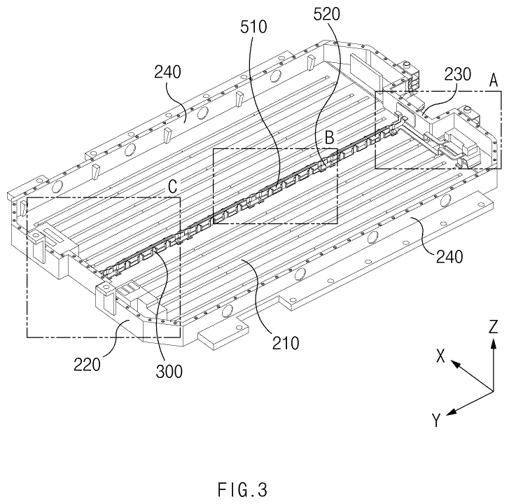

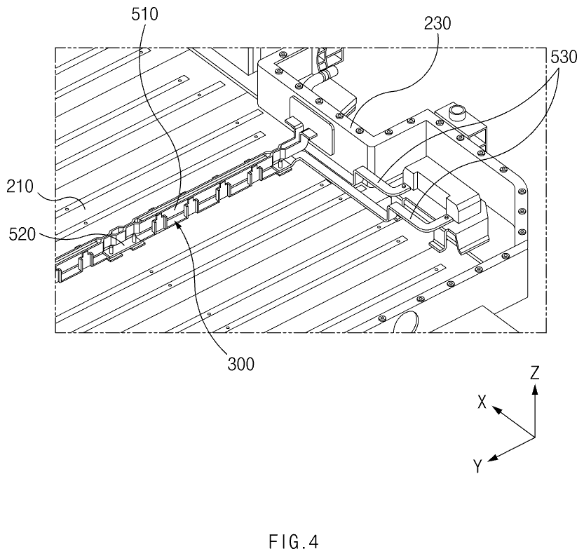

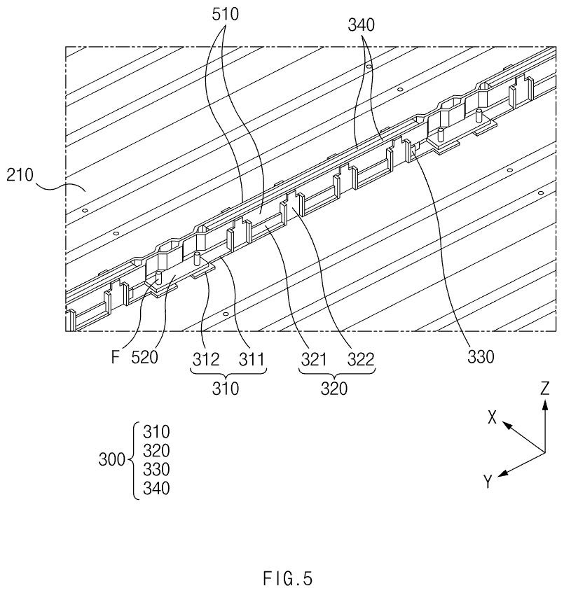

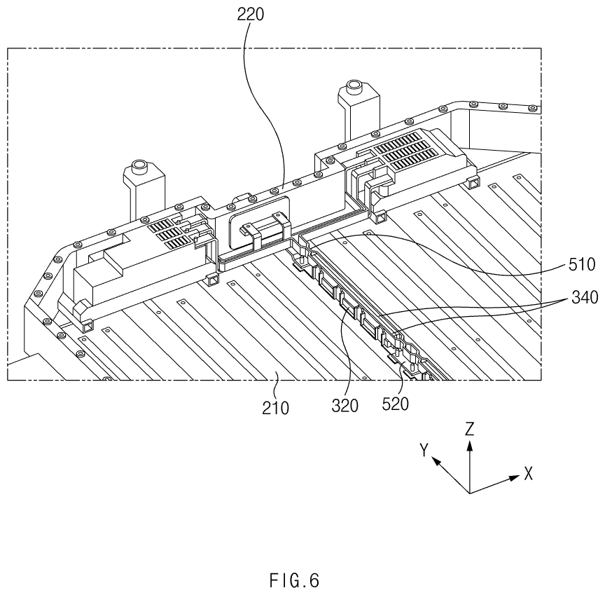

FIG. 1 is an exploded perspective view of a battery pack according to an embodiment of the present disclosure. FIG. 2 is a perspective view of a battery housing before an electric part module is mounted according to an embodiment of the present disclosure. FIG. 3 is a perspective view of a battery housing, on which an electric part module is mounted, according to an embodiment of the present disclosure. FIG. 4 is an enlarged view of portion “A” illustrated in FIG. 3. FIG. 5 is an enlarged view of portion “B” illustrated in FIG. 3. FIG. 6 is an enlarged view of portion “C”illustrated in FIG. 3.

Referring to FIGS. 1 to 6, a battery pack 100 may include a battery housing 200, a plurality of battery cell stacks 400 that are accommodated in the battery housing 200, an electric part module 500, and a pack cover 600 that is coupled to the battery housing 200 to cover the plurality of battery cell stacks 400 and the electric part module 500.

The battery housing 200 may include a base plate 210, on which the plurality of battery cell stacks 400 are seated, and a front member 220, a rear member 230, and side members 240 that are coupled to the base plate 210 along a circumference of the base plate 210, respectively.

The front member 220 may be disposed on one side (the “Y” direction) of the base plate 210 in the second direction, and the rear member 230 may be disposed on an opposite side (an opposite direction to the “Y”direction) of the base plate 210 in the second direction.

The side members 240 may extend to connect the front member 220 and the rear member 230 on opposite sides (i.e., the “X” direction and an opposite direction to the “X” direction) of the base plate 210 in the first direction.

The battery housing 200 may accommodate the battery cell stacks 400 through a space that is defined by the front member 220, the rear member 230, the side members 240, and the base plate 210.

A plurality of battery cell stacks 400 may be provided and may be spaced apart from each other in the first direction and disposed to face each other. As an example, the plurality of battery cell stacks 400 may be provided as eight battery cell stacks 400. Among the plurality of battery cell stacks 400, four battery cell stacks 400 may be disposed on one side (the “X” direction) of the battery housing 200 in the first direction with respect to a central area in the first direction, and, among a plurality of battery cell stacks 400, the other four battery cell stacks 400 may be disposed on an opposite side (an opposite direction to the “X” direction) of the battery housing 200 in the first direction with respect to the central area in the first direction. However, the number and disposition of battery cell stacks 400 are not limited thereto.

The battery housing 200 may include first cross members 250 that extend in the second direction between the plurality of battery cell stacks 400 in the first direction and a plurality of second cross members 260 that extend in the first direction to cross the first cross members 250 between the plurality of battery cell stacks 400 in the second direction. The second cross members 260 may be formed to be disposed on opposite sides of each of the battery cell stacks 400 in the second direction.

Meanwhile, the electric part module 500 may include a power relay assembly, a fuse assembly, and a battery management system (BMS). The power relay assembly may connect or disconnect electric power that is generated in the battery cell stacks 400 to other parts of the electric vehicle.

The fuse assembly may be a configuration for disconnecting an electrical connection of the other parts of the electric part module or the battery cell stack 400 when there is an abnormality in the other parts of the electric part module or the battery cell stack 400.

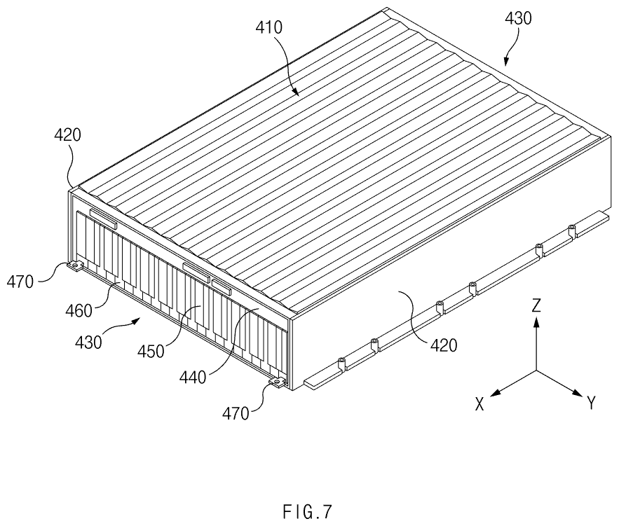

The BMS may be a configuration for acquiring information on the voltage, temperature, current, and the like of the battery cells 410 (see FIG. 7) of the battery cell stack 400 to control the battery cell stack 400 or transmit the information to the power relay assembly.

Furthermore, the electric part module 500 may include a busbar 510, an inter-busbar 520, and a communication busbar 530. Here, the busbar 510 is a busbar for a high voltage, and may have a configuration, in which a relatively large current or a relatively high voltage flows in the battery pack 100 according to the present disclosure. The busbar 510 may be connected to the power relay assembly.

The busbar 510 may be connected to a high voltage connector provided in at least one of areas on opposite sides of the battery housing 200 in the second direction. The busbar 510 may supply electric power to other components of the vehicle provided on opposite sides of the battery pack 100 in the second direction. To this end, the busbar 510 may extend in the second direction.

The inter-busbar 520 may be a configuration for to electrically connecting a pair of battery cell stacks 400 that are arranged adjacent to each other in the second direction.

The communication busbar 530 may be a configuration for connecting the battery cell stack 400 to the BMS or the battery cell stack 400 and the power relay assembly.

Meanwhile, when a fire occurs in the interior of the battery housing 200, the cover of the busbar 510 is damaged when the busbar 510 is exposed to the fire, and thus a thermal runaway of the battery pack 100 may occur more significantly. To prevent this, the busbar 510 of the battery pack 100 according to an embodiment of the present disclosure may extend in the second direction in an area between the plurality of battery cell stacks 400 in the first direction, not in one side area of the battery cell stack 400 in the third direction.

To maintain a state, in which the busbar 510 is prevented from being exposed from a fire, the position of the busbar 510 needs to be fixed. To this end, the battery housing 200 may include a busbar holder 300 that fixes the position of the busbar 510 between a first cross member 250 and the base plate 210. The busbar holder 300 may extend between the front member 220 and the rear member 230 along a central area of the base plate 210 in the first direction.

As illustrated in FIGS. 2 and 3, the busbar holder 300 may be coupled to the base plate 210 and mounted on the base plate 210 in the process of manufacturing the battery pack 100. The busbar holder 300 may be formed of a that may be injection-molded to be easily coupled to the base plate 210.

As illustrated in FIG. 5, the busbar holder 300 may include a base wall 310, a pair of side walls 320, a pair of busbar support walls 330, and a pair of spacers 340.

The base wall 310 may be fixed to the base plate 210. The pair of side walls 320 may extend from opposite side ends of the base wall 310 in the first direction to one side (the “Z” direction) in the third direction, respectively.

The pair of busbar support walls 330 may protrude from the base wall 310 to one side in the third direction between the pair of side walls 320 to support the busbar 510.

The pair of spacers 340 may protrude from the base wall 310 to one side in the third direction between the pair of busbar support walls 330 to space the pair of busbars 510 apart from each other. The pair of spacers 340 may be disposed in parallel to each other.

More specifically, the pair of side walls 320 may accommodate the busbar 510 between the pair of side walls 320. To this end, a height, by which each of the pair of side walls 320 extends from the base wall 310 to one side in the third direction, may be greater than a height, by which the busbar support wall 330 protrudes from the base wall 310 to one side in the third direction. In other words, a height of the busbar support wall 330 in the third direction may be smaller than a height of the side wall 320 in the third direction.

The side wall 320 may include side connection areas 321 that are connected to the base wall 310 and extend in the second direction, and side support areas 322 that are arranged in the second direction with the side connection area 321 interposed therebetween.

The side connection areas 321 and the side support areas 322 may be alternately arranged along the second direction. The side connection area 321 may connect a pair of side support areas 322 that are adjacent to each other in the second direction.

A height that extends from the base wall 310 of the side support area 322 to one side in the third direction may be higher than a height that extends from the base wall 310 of the side connection area 321 to one side in the third direction. In other words, a height of the side support area 322 in the third direction may be greater than a height of the side connection area 321 in the third direction.

Furthermore, the side support area 322 may include a portion having a thickness in the first direction that is greater than the thickness of the side connection area 321 in the first direction. This may be to reinforce a rigidity of the side support area 322. For this reason, even when, among the areas between the side support areas 322, an area that is not provided with the side connection area 321 does not support the busbar 510, the busbar 510 may be fixed by the busbar holder 300.

Meanwhile, the base wall 310 may extend in the second direction from a central area of the base plate 210 in the first direction.

The base wall 310 may include a base area 311 that is connected to the side wall 320 and the busbar support wall 330, and protruding areas 312 that protrude from the base area 311 to opposite sides in the first direction toward the battery cell stack 400, respectively. The protruding area 312 may be a partial area of the base wall 310, which is coupled to the inter-busbar 520 to support the inter-busbar 520.

The inter-busbar 520 may be disposed adjacent to an area that is provided between the pair of battery cell stacks 400 that are adjacent to each other in the second direction. The disposition of the inter-busbar 520 may be because the inter-busbar 520 is a configuration for electrically connecting a pair of battery cell stacks 400 that are adjacent to each other in the second direction.

The inter-busbar 520 may extend in the second direction and may include opposite ends in the second direction. The opposite ends of the inter-busbar 520 may be coupled to the protruding area 312 of the base wall 310 by a coupling member “F”. Here, the coupling member “F” may be a configuration for coupling the opposite ends of the inter-busbar 520 and the protruding area 312.

The inter-busbar 520 may be disposed between the busbar 510 and the base wall 310 in the third direction. This is because the inter-busbar 520 may be disposed on the protruding area 312 of the base wall 310 and the busbar 510 may be seated on the busbar support wall 330 that protrudes from the base wall 310 to one side in the third direction.

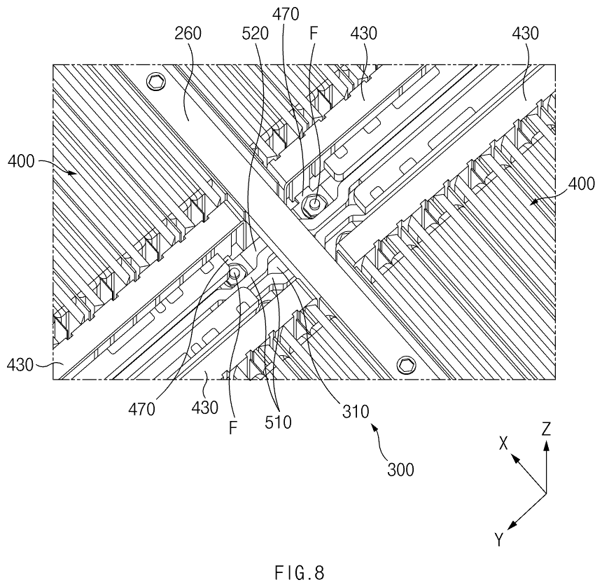

FIG. 7 is a perspective view of a battery cell stack according to an embodiment of the present disclosure. FIG. 8 is an enlarged view illustrating an inter-busbar, a connection terminal, and a busbar, between battery cell stacks according to an embodiment of the present disclosure.

Referring to FIGS. 7 and 8, the battery cell stack 400 may include battery cells 410 that extend in the first direction and are arranged in the second direction, and end plates 420 that are disposed at opposite sides of the battery cell 410 in the second direction to prevent a swelling phenomenon of the battery cells 410.

The battery cell stack 400 may include a sensing assembly 430 that are provided on opposite sides of the battery cell 410 in the first direction, and a cover (not illustrated) that covers an outer side of the sensing assembly 430 in the first direction.

The sensing assembly 430 may include a board 440, a sensing busbar 450 that is connected to the board 440, and a sensing frame 460 that supports the board 440 and the sensing busbar 450.

The board 440 may be configured to extend in the second direction from an area of the sensing frame 460 on one side in the third direction and may be attached to the sensing frame 460.

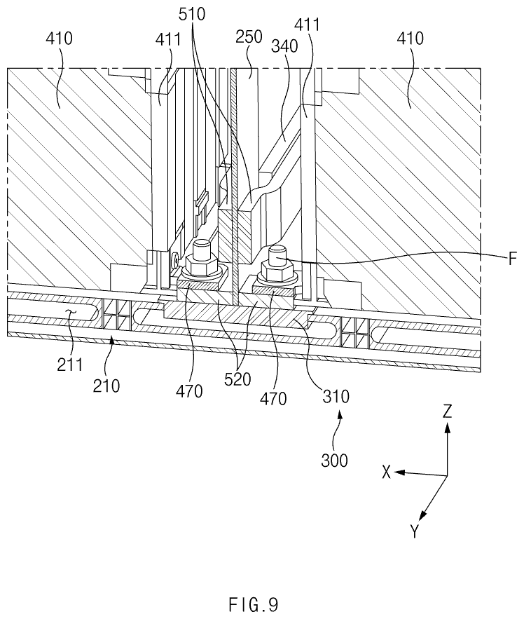

The sensing busbar 450 may be connected to the board 440. The sensing busbar 450 may extend from the board 440 to an opposite side in the third direction and may be arranged to be spaced apart from each other along the second direction. The sensing busbar 450 may be electrically connected to a cell lead 411 (see FIG. 9) of the battery cell 410.

Sensing frames 460 may be disposed on opposite sides of the battery cell 410 in the first direction to support the board 440 and the sensing busbar 450.

The sensing assembly 430 may include a connection terminal 470 that is electrically connected to the sensing busbar 450. The connection terminal 470 may be connected to each of the sensing busbars 450 provided at opposite ends in the second direction, among a plurality of sensing busbars 450 pertaining to the battery cell stack 400 and may protrude outward from the sensing busbar 450 in the first direction.

Furthermore, the connection terminal 470 may be a configuration for electrically connecting the inter-busbar 520 to the sensing busbar 450. Because the inter-busbar 520 according to an embodiment of the present disclosure may be provided in the opposite side area in the third direction in the interior of the battery housing 200 (refer to FIG. 2) to be coupled to the base wall 310, the connection terminal 470 may be provided on the opposite side area of the sensing assembly 430 in the third direction.

According to the structure, the connection terminal 470 may be more easily coupled to the inter-busbar 520 that is provided adjacent to the base plate 210 in the interior of the battery housing 200, and information on the battery cells 410 of the battery cell stack 400 may be transmitted to the BMS through the inter-busbar 520, or a signal for controlling the battery cells 410 may be received from the BMS.

Furthermore, as the battery cell 410 extends in the first direction, the connection terminal 470 may protrude toward the center area of the base plate 210 (see FIG. 5), so that the inter-busbar 520 may be disposed on the center area of the battery housing 200 in the first direction.

Meanwhile, as illustrated in FIG. 8, the second cross member 260 may extend in the first direction between the opposite ends of the inter-busbar 520 in the second direction.

Furthermore, when the busbar 510, the inter-busbar 520, and the protruding area 312 (see FIG. 5) is viewed while being spaced apart in the third direction, the busbar 510 may include an area having a curved shape to become more distant from opposite ends in the second direction of inter-busbar 520 in the first direction.

For example, the coupling member “F” for coupling the opposite ends of the inter-busbar 520, and the inter-busbar 520 and the connection terminal 470 needs to be fixed by a tool. For the tool to fix the coupling member “F”, it needs to be inserted from one side in the third direction toward the coupling member “F”, and to this end, and to this end, the opposite ends of the inter-busbar 520 and the area of the connection terminal 470 in the third direction need to be opened to one side in the third direction.

To this end, an area of the busbar 510, which is adjacent to each of the opposite ends of the inter-busbar 520 in the second direction, may include an area having a curved shape so as to become more distant from each of the opposite ends of the inter-busbar 520 in the first direction.

With the structure, in the process of manufacturing the battery pack 100 (see to FIG. 1), the busbar 510 and the inter-busbar 520 are seated on the busbar holder 300, the connection terminal 470 is seated to be connected to the opposite ends of the inter-busbar 520, and then the base wall 310 (see FIG. 5), the inter-busbar 520, and the connection terminal 470 of the busbar holder 300 may be more easily coupled to each other by the coupling member “F” and the tool.

FIG. 9 is a cross-sectional view of a busbar, an inter-busbar, a connection terminal, and a base plate provided between battery cell stacks according to an embodiment of the present disclosure.

Referring to FIG. 9, the base wall 310 may be coupled to the base plate 210, and the inter-busbar 520 and the connection terminal 470 may be connected to each other on the protruding area 312 (FIG. 5) of the base wall 310 through the coupling member “F”.

For example, the inter-busbar 520 may be disposed on the opposite side area of the busbar 510 in the third direction. When the busbar 510 and the inter-busbar 520 are viewed while being spaced apart from each other in the second direction, the inter-busbar 520 and the busbar 510 may extend in directions that are perpendicular to each other.

More specifically, the inter-busbar 520 may have a length in the first direction that is greater than a length in the third direction, and the busbar 510 may be spaced apart from the inter-busbar 520 in the third direction so that a length thereof in the third direction is greater than a length thereof in the first direction.

According to the structure, a space utilization may be relatively optimized on one side area of the second cross member 260 in the third direction while a spacing distance between the inter-busbar 520 and the busbar 510 is maintained.

Furthermore, because the base plate 210 may include a cooling channel 211 in an interior thereof, it is possible to prevent a temperature of the busbar 510 and the inter-busbar (520) disposed relatively adjacent to the base plate 210 from rising. Accordingly, a safety of the battery pack 100 may be improved.

Furthermore, the first cross member 250 may be disposed between the pair of spacers 340. The first cross member 250 may be a configuration for insulating, among the areas of the battery housing 200 (see FIG. 2) two areas that are partitioned from each other in the first direction by the first cross member 250.

Due to the first cross member 250 and the second cross member 260 (see FIG. 8), even when a fire occurs in any one of the plurality of battery cell stacks 400, flame or gas may be prevented from being delivered to another adjacent battery cell stack 400, and thus, a thermal runaway of the battery pack 100 (see FIG. 1) may be prevented.

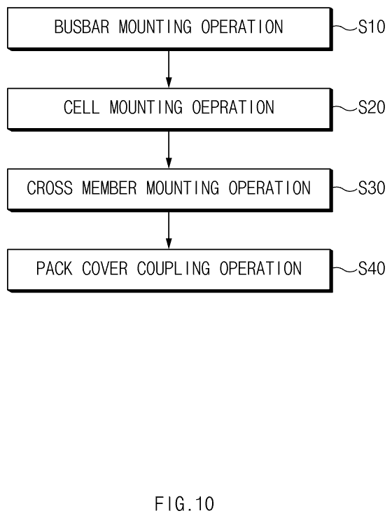

FIG. 10 is a flowchart illustrating a method for manufacturing a battery pack according to an embodiment of the present disclosure.

Referring to FIGS. 1 and 10, a method for manufacturing a battery pack 100 may include a busbar mounting operation S10, a cell mounting operation S20, a cross member mounting operation S30, and a pack cover coupling operation S40.

The busbar mounting operation S10 may be an operation of mounting a busbar 510 on a busbar holder 300 of a battery housing 200.

The busbar mounting operation S10 may include fixing the busbar holder 300 for fixing the busbar 510 to the base plate 210 and then seating the busbar 510 on the busbar holder 300.

Furthermore, the busbar mounting operation S10 may include fixing the busbar holder 300 for fixing the busbar 510 to base plate 210, and mounting the inter-busbar 520 for electrical connection of the battery cell stacks 400 to battery housing 200.

Furthermore, the busbar mounting operation S10 may include mounting the remaining parts of the battery housing 200, except for the busbar 510 and the inter-busbar 520 of the electric part module 500, in an interior of the battery housing 200.

The cell mounting operation S20 may be an operation of mounting a plurality of cell stacks 400 on the battery housing 200 such that they face each other in the first direction with the busbar 510 interposed therebetween after the busbar mounting operation S10.

For example, the battery cell stack 400 may be in a state, in which the end plates 420 are stacked at opposite sides of the battery cell 410 in the second direction after the battery cells 410 that extend in the first direction and arranged in the second direction, and the cooling plate or the surface pressure member are stacked together.

Furthermore, the battery cell stack 400 may be, in a state in which the sensing assemblies 430 are assembled on opposite sides of the battery cell 410 in the first direction after the end plates 420 are stacked, and the cell lead 411 (see FIG. 9) is welded to the sensing busbar 450. Thereafter, a cover for covering the battery cells 410 or the sensing assembly 430 may be assembled on an outer side of the sensing assembly 430 in the first direction.

The cell mounting operation S20 may include electrically connecting the connection terminal 470 and the inter-busbar 520 of the battery cell stack 400. The cell mounting operation S20 may include connecting the connection terminal 470 and the inter-busbar 520, and coupling the busbar holder 300, the inter-busbar 520, and the connection terminal 470 so that the electrical connection of the busbar holder 300, the inter-busbar 520, and the connection terminal 470 is maintained.

The cross member mounting operation S30 may be an operation of mounting a first cross member 250 that extends in the second direction and a second cross member 260 that is disposed in a direction that crosses the first cross member 250 on the battery housing 200 between the plurality of battery cell stacks 400, after the cell mounting operation S20.

More specifically, the cross member mounting operation S30 may include mounting the first cross member 250 in the interior of the battery housing 200 between the pair of spacers 340, and mounting the second cross member 260 in the interior of the battery housing 200 between the battery cell stacks 400 that are adjacent to each other in the second direction.

Here, the mounting order of the second cross member 260 may precede the first cross member 250, but the present disclosure is not limited thereto.

The pack cover coupling operation S40 may be an operation of coupling the pack cover 600 to the battery housing 200 after the cross member mounting operation S30.

According to the above-described method for manufacturing the battery pack 100, because the battery cell stack 400 may be assembled in a stack unit and be mounted in the interior of the battery housing 200, on which the electric part module 500, such as the busbar 510 or the inter-busbar 520, is mounted, the manufacturing process of the battery pack 100 becomes relatively simple, and thus, the productivity of the battery pack 100 may be improved.

According to the present technology, because the busbar holder fixes the busbar, the busbar is prevented from being exposed in the interior of the battery housing, so even though a fire occurs from the battery cell, the thermal runaway caused by the busbar may be prevented from spreading.

In addition, according to the present technology, because a separate part for fixing the busbar by the busbar holder is not required, a productivity of the battery pack may be improved due to the cost reduction caused by the separate part.

In addition, according to the present technology, because the busbar and the inter-busbar are fixed in position while being adjacent to the base plate, the temperatures of the busbar and the inter-busbar may be prevented from rising due to the cooling channel provided in the interior of the base plate.

In addition, according to the present technology, due to the curved shape of the busbar, the coupling member and the tool may be easily inserted when the inter-busbar and the connection terminal of the battery cell stack are coupled to each other, so that the productivity of the battery pack may be improved.

In addition, various effects that are directly or indirectly identified through this document may be provided.

The above description is a simple exemplary description of the technical spirits of the present disclosure, and an ordinary person in the art, to which the present disclosure pertains, may make various corrections and modifications without departing from the essential characteristics of the present disclosure.

Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. A battery pack comprising:
a battery housing;
a plurality of battery cell stacks configured to be accommodated in an interior of the battery housing and disposed to be spaced apart from each other in a first direction; and
a busbar extending in a second direction crossing the first direction between the plurality of battery cell stacks,
wherein the battery housing comprises:
a base plate on which the plurality of battery cell stacks is configured to be seated;
a first cross member extending in the second direction between the plurality of battery cell stacks; and
a busbar holder configured to fix a position of the busbar between the first cross member and the base plate.

2. The battery pack of claim 1, wherein the busbar holder comprises:
a base wall fixed to the base plate; and
a pair of side walls extending from the base wall to one side in a third direction crossing the first direction and the second direction, the pair of side walls accommodating the busbar therebetween.

3. The battery pack of claim 2, wherein the busbar holder further comprises a busbar support wall protruding from the base wall in the third direction between the pair of side walls and supporting the busbar.

4. The battery pack of claim 3, wherein a height of the busbar support wall in the third direction is smaller than a height of the side walls in the third direction.

5. The battery pack of claim 3, further comprising an inter-busbar configured to electrically connect the battery cell stacks arranged in parallel in the second direction,
wherein the base wall is configured to support the inter-busbar.

6. The battery pack of claim 5, wherein the base wall comprises:
a base area connected to the side wall and the busbar support wall; and
a protruding area protruding from the base area toward the battery cell stacks and coupled to the inter-busbar.

7. The battery pack of claim 6, wherein the inter-busbar extends in the second direction and comprises opposite ends in the second direction, and
wherein the protruding area is coupled to the opposite ends of the inter-busbar.

8. The battery pack of claim 7, further comprising
a second cross member extending in the first direction to cross the first cross member between the opposite ends of the inter-busbar.

9. The battery pack of claim 7, further comprising:
a coupling member coupling the opposite ends of the inter-busbar and the protruding area,
wherein when the busbar and the inter-busbar are viewed while being spaced apart from each other in the third direction, the busbar comprises an area that is curved to become more distant from the opposite ends of the inter-busbar in the first direction.

10. The battery pack of claim 5, wherein the inter-busbar is disposed between the busbar and the base wall.

11. The battery pack of claim 5, wherein when the busbar and the inter-busbar are viewed while being spaced apart from each other in the second direction,
the inter-busbar has a length in the first direction that is greater than a length in the third direction, and
the busbar is spaced apart from the inter-busbar in the third direction to have a length in the third direction being greater than a length in the first direction.

12. The battery pack of claim 5, wherein the battery cell stack comprises:
battery cells extending in the first direction and arranged in the second direction; and
a sensing assembly disposed on one side of the battery cells in the first direction and electrically connected to the inter-busbar.

13. The battery pack of claim 12, wherein the connection terminal is provided on an area on an opposite side of the sensing assembly in the third direction.

14. The battery pack of claim 2, wherein each of the side wall comprises:
a side connection area extending in the second direction; and
side support areas arranged in the second direction with the side connection area interposed therebetween, having a height in the third direction that is greater than a height of the side connection area in the third direction, and supporting the busbar.

15. The battery pack of claim 14, wherein the side support area comprises a part having a thickness in the first direction being greater than a thickness of the side connection area in the first direction.

16. The battery pack of claim 1, wherein the base plate comprises a cooling channel in an interior thereof.

17. A method for manufacturing a battery pack, the method comprising:
mounting a busbar on a battery housing;
mounting a plurality of battery cell stacks on the battery housing such that the plurality of battery cell stacks faces each other with the busbar interposed therebetween;
mounting a first cross member and a second cross member in a direction crossing the first cross member, between the plurality of battery cell stacks; and
coupling a pack cover to the battery housing.

18. The method of claim 17, wherein the mounting the busbar on the battery housing comprises:
fixing a busbar holder for fixing the busbar to a base plate; and
seating the busbar on the busbar holder.

19. The method of claim 17, wherein the mounting the busbar on the battery housing comprises:
fixing a busbar holder for fixing the busbar to a base plate; and
mounting an inter-busbar for electrical connection of the battery cell stacks on the battery housing.

20. The method of claim 19, wherein the mounting the plurality of battery cell stacks on the battery housing comprises:
electrically connecting the inter-busbar and connection terminals of the battery cell stacks.
